(19) United States
(12) Patent Application Publication
(10) Pub. No.: US 2025/0289357 A1
(43) Pub. Date: Sep. 18, 2025

(54) SYSTEM AND METHOD FOR A VEHICLE SYSTEM

(71) Applicant: Bowen Customs, Arvada, CO (US)

(72) Inventor: Brenton Bowen, Arvada, CO (US)

(73) Assignee: Bowen Customs, Arvada, CO (US)

(21) Appl. No.: 19/225,887

(22) Filed: Jun. 2, 2025

Related U.S. Application Data
(63) Continuation of application No. 18/180,671, filed on Mar. 8, 2023.

(51) Int. Cl. B60P 3/39

(52) U.S. Cl. CPC B60P 3/39

(57) ABSTRACT

A vehicle system includes a vehicle including a frame and a factory bed which has been removed from the frame. The factory bed had a factory bed height when the factory bed was attached to the vehicle. The factory bed height is a height of the factory bed above factory frame rail mounting points when the factory bed was attached to the frame and the vehicle is stationary on level ground. The vehicle system also includes a custom bed attached to the frame. The custom bed includes a deck attached to the frame and at least one box for storage attached to the deck. The deck defines a custom bed height that is approximately equal to the factory bed height. The custom bed height is a height of the deck above factory frame rail mounting points when the custom bed is attached to the frame and the vehicle is stationary on level ground.

### CROSS REFERENCE TO RELATED APPLICATION

This application is a continuation of U.S. patent application Ser. No. 18/180,671, filed Mar. 8, 2023, and entitled SYSTEM AND METHOD FOR A VEHICLE SYSTEM, the disclosure of which is incorporated herein by reference in its entirety.

### BACKGROUND OF CERTAIN ASPECTS OF THE DISCLOSURE

Vehicles, typically trucks, have frames and factory beds attached to the frames. At least some vehicle owners desire a bed that is more suited to their needs. For example, at least some vehicle owners desire a bed that includes more storage, is configured to receive a topper/camper (e.g., a truck topper, a camper, a rack, etc.), enables greater wheel travel, has a greater departure angle, and/or has a more rugged aesthetic than the factory beds. The factory beds each define a factory bed height that is a height of the factory bed above factory frame rail mounting points when the vehicle is stationary on level ground. The design of the factory bed (including the factory bed height) may not be suited to receive certain types of toppers/campers, enable wheel travel suited to certain off road conditions, and/or accommodate a departure angle suited to certain off road conditions. As such, at least some vehicle owners remove the factory bed and install a custom bed in its place.

The custom bed typically has a custom bed height that is higher than the factory bed height. Additionally, at least some vehicle owners add a topper/camper to the custom bed. However, because the bed height is higher than the factory height and because the topper/camper can add a significant amount of weight to the vehicle, the center of gravity of the vehicle may be increased, adversely affecting the stability of the vehicle and the smoothness of the ride of the vehicle. Specifically, the vehicle may ride rougher because the center of gravity of the vehicle has increased.

Moreover, maintaining the custom bed height at the factory bed height may be incompatible with increasing the off road capabilities of the vehicle and improving the rugged aesthetic of the vehicle. For example, at least some vehicles configured for off road and/or rugged terrain have a high wheel travel, a high departure angle, and an off road, rugged aesthetic to improve the vehicles off road capabilities. A high wheel travel and a high departure angle are typically indications of the off road capabilities of a vehicle. An off road, rugged aesthetic may be important to the vehicle owner because the aesthetic may be a cultural/styling signal to other drivers. Maintaining the custom bed height at the factory bed height may limit the wheel travel and/or the departure angle of the vehicle, limiting the off road capabilities of the vehicle.

Accordingly, there is a need for a custom bed that has a bed height that is approximately equal to the factory height of the vehicle with a high wheel travel, a high departure angle, and an off road, rugged aesthetic.

### BRIEF SUMMARY OF SOME ASPECTS OF THE DISCLOSURE

A number of embodiments of a vehicle system are presented in this application. The embodiments described herein include a vehicle including a frame and a factory bed which has been removed from the frame. The frame includes at least one factory frame rail mounting point. The factory bed had a factory bed height when the factory bed was attached to the vehicle. The factory bed height is a height of the factory bed above the at least one factory frame rail mounting point when the factory bed was attached to the frame. The vehicle system also includes a custom bed attached to the frame. The custom bed includes a deck attached to the frame and at least one box for storage attached to the deck above the deck. The deck defines a custom bed height that is approximately equal to or lower than the factory bed height. The custom bed height is a height of the deck above the at least one factory frame rail mounting point when the custom bed is attached to the frame.

The embodiments described herein also include a method of manufacturing a vehicle system. The method includes providing a vehicle including a frame and a factory bed attached to the frame. The frame includes at least one factory frame rail mounting point. The factory bed has a factory bed height when the factory bed is attached to the frame. The factory bed height is a height of the factory bed above the at least one factory frame rail mounting point when the factory bed is attached to the frame. The method also includes removing the factory bed from the frame. The method further includes attaching a custom bed the frame. The custom bed includes a deck attached to the frame and at least one box for storage attached to the deck above the deck. The deck defines a custom bed height that is approximately equal to or lower than the factory bed height. The custom bed height is a height of the deck above the at least one factory frame rail mounting point when the custom bed is attached to the frame.

There are other novel aspects and features of this disclosure. They will become apparent as this specification proceeds. Accordingly, this brief summary is provided to introduce a selection of concepts in a simplified form that are further described below in the detailed description. The summary and the background are not intended to identify key concepts or essential aspects of the disclosed subject matter, nor should they be used to constrict or limit the scope of the claims. For example, the scope of the claims should not be limited based on whether the recited subject matter includes any or all aspects noted in the summary and/or addresses any of the issues noted in the background.

### DRAWINGS

The preferred and other embodiments are disclosed in association with the accompanying drawings in which:

FIG. 1 illustrates a perspective view of a vehicle system in accordance with aspects of the present disclosure.

FIG. 2 illustrates a perspective view of an alternative embodiment of the custom bed illustrated in FIG. 1 in accordance with aspects of the present disclosure.

FIG. 3 illustrates another perspective view of the custom bed illustrated in FIG. 2 in accordance with aspects of the present disclosure.

FIG. 4 illustrates an exploded perspective view of the custom bed illustrated in FIGS. 2 and 3 in accordance with aspects of the present disclosure.

FIG. 5 illustrates a side view of the custom bed illustrated in FIGS. 2 and 3 in accordance with aspects of the present disclosure.

FIG. 6 illustrates another side view of the custom bed illustrated in FIGS. 2 and 3 in accordance with aspects of the present disclosure.

FIG. 7 illustrates a top view of the custom bed illustrated in FIGS. 2 and 3 in accordance with aspects of the present disclosure.

FIG. 8 illustrates a bottom view of the custom bed illustrated in FIGS. 2 and 3 in accordance with aspects of the present disclosure.

FIG. 9 illustrates a front view of the custom bed illustrated in FIGS. 2 and 3 in accordance with aspects of the present disclosure.

FIG. 10 illustrates a back view of the custom bed illustrated in FIGS. 2 and 3 in accordance with aspects of the present disclosure.

FIG. 11 illustrates a perspective view of the custom bed illustrated in FIG. 1 in accordance with aspects of the present disclosure.

FIG. 12 illustrates a flow diagram of a method of manufacturing the vehicle systems illustrated in FIGS. 1-11 in accordance with aspects of the present disclosure.

### DETAILED DESCRIPTION

A number of embodiments of a system and method for a vehicle system including a custom bed are presented in this application. In general, the custom bed improves the capabilities and the aesthetic of the vehicle system while minimizing increases in the center of mass of the vehicle system. Specifically, the custom bed is sized and shaped to maintain a custom bed height at a height that is approximately equal to a factory bed height, enable an increased a factory wheel travel to a custom wheel travel, increase a factory departure angle to a custom departure angle, and change the overall aesthetic of the vehicle system to a more rugged aesthetic. The potential increase of the wheel travel and the increased departure angle increase the off road capabilities of the vehicle system. Maintaining the custom bed height at a height that is approximately equal to the factory bed height, minimizes increases in the center of mass of the vehicle system, improving the stability and the ride of the vehicle system. The shape of the custom bed changes the aesthetic of the vehicle system to a more rugged aesthetic. Accordingly, the custom beds described herein improves the capabilities of the vehicle system while minimizing increases in the center of mass of the vehicle system.

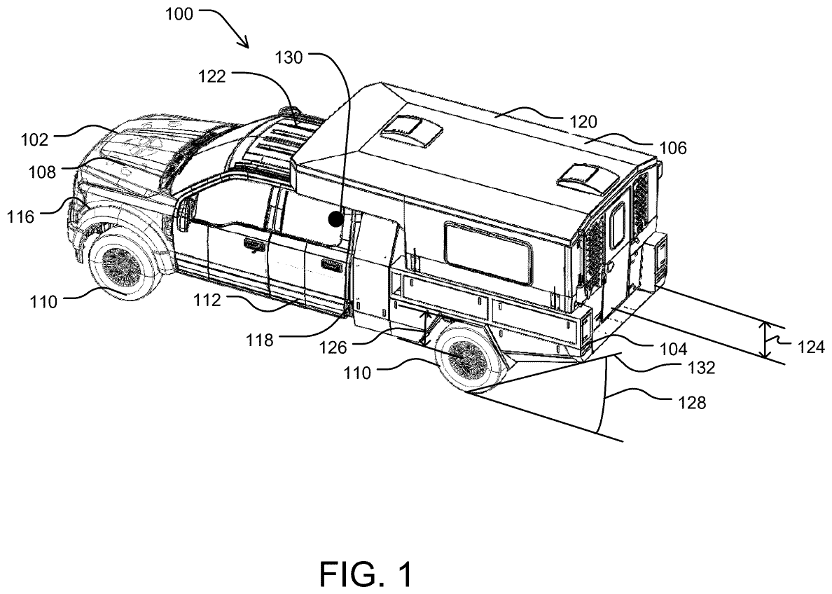

FIG. 1 is a perspective view of a vehicle system 100. The vehicle system 100 includes a vehicle 102, a custom bed 104, and a topper/camper 106. In the illustrated embodiment, the custom bed 104 is a custom bed that is added after a factory bed has been removed. The custom bed 104 has an off road, rugged aesthetic, a potentially higher wheel travel, and a high departure angle that is typical of many off-road vehicles and gives the vehicle system 100 the ability to travel over difficult and rugged terrain. Additionally, a custom bed height of the custom bed 104 is equal to a factory bed height of the factory bed that has been removed. As such, the center of gravity of vehicle system 100 has remained approximately the same as the center of gravity of the vehicle system 100 before the factory bed was removed. Thus, the addition of the custom bed 104 has not adversely affected the center of gravity of the vehicle system 100 while the wheel travel and the departure angle of the vehicle system 100 have been improved, maintaining the stability of the vehicle system 100 and improving the capabilities of the vehicle system 100.

The vehicle 102 includes an engine 108, a frame (not shown), wheels 110, a body 112, and a factory bed (not shown). The frame includes at least one factory frame rail mounting point that mounts the factory bed to the frame. In the illustrated embodiment, the frame includes a plurality of factory frame rail mounting points that mounts the factory bed to the frame. The factory bed has been removed and the custom bed 104 has replaced the factory bed. Specifically, the factory bed was attached to the frame. The factory bed has been detached from the frame and the custom bed 104 has been attached to the frame in place of the factory bed. The engine 108 powers the wheels 110 to drive the vehicle 102. The body 112 includes a first end 116 and a second end 118. The first end 116 includes the engine 108 and the bed 104 is attached to the second end 118. As shown in FIG. 1, in the illustrated embodiment, the vehicle 102 includes a truck. In alternative embodiments, the vehicle 102 may include any type of vehicle that enables vehicle system 100 to operate as described herein.

In the illustrated embodiment, the topper/camper 106 includes a truck topper/camper (also sometimes called a canopy, camper shell, truck cap, bed cap, box cap, or simply shell). The truck topper/camper is typically a small housing or rigid canopy used as a pickup truck accessory. The housing is typically made of fiberglass or aluminum and is mounted on top of the custom bed 104 or the factory bed. In the illustrated embodiment, the topper/camper 106 covers the entire custom bed 104 and may be large enough to be used for camping purposes. However, in alternative embodiments, the topper/camper 106 may cover only a portion of the custom bed 104. Typically, a top 120 of the topper/camper 106 is even with or above a top 122 of the body 112.

In alternative embodiments, the topper/camper 106 may not be a truck topper/camper. Rather, the topper/camper 106 may be any structure attached to the bed 104 that enables the vehicle system 100 to operate as described herein. For example, in some embodiments, the top of 106 may be a camper and/or a truck rack attached to the bed 104. Additionally, in some embodiments, the vehicle system 100 may not include a topper/camper 106.

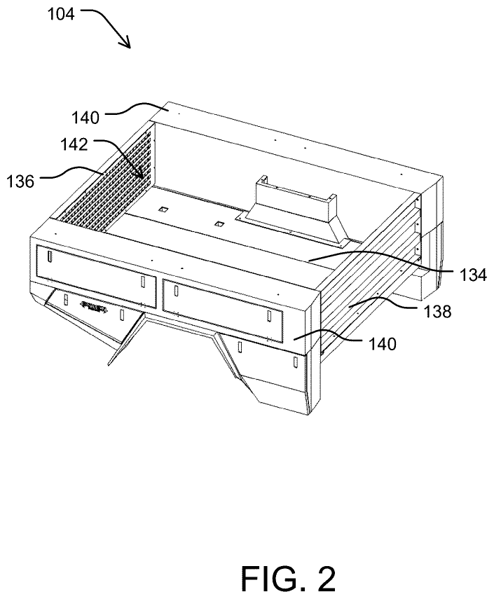

As shown in FIG. 1, the vehicle system 100 defines a custom bed height 124, a custom wheel travel 126, a custom departure angle 128, and a custom center of gravity 130. In general, a bed height is defined as a height of a bed above factory frame rail mounting points when the vehicle system 100 is stationary on level ground. In the illustrated embodiment, the custom bed height 124 is the height of a deck 134 (shown in FIGS. 2-10) of the custom bed 104 above factory frame rail mounting points when the vehicle system 100 is stationary on level ground. A factory bed height (not shown) is the height of a deck (not shown) of the factory bed (not shown) above factory frame rail mounting points when the factory bed is attached to the frame and the vehicle system 100 is stationary on level ground. In the illustrated embodiment, the custom bed height 124 is approximately equal to or lower than the factory bed height.

In general, a wheel travel is defined as a distance from a bottom of a suspension stroke (such as when the vehicle 102 is on a jack, and the wheels 110 hang freely) to a top of the suspension stroke (such as when the vehicle's 102 wheel can no longer travel in an upward direction toward the vehicle 102). Bottoming or lifting a wheel can cause serious control problems, or directly cause damage to the vehicle 102. For example, bottoming may be caused by the suspension, tires, and/or fenders running out of space to move, or the body or other components of the vehicle 102 hitting the road. A higher wheel travel typically reduces the likelihood of damage when the vehicle system 100 is traveling over rugged or off road terrain because the wheels 110 have a greater distance to travel before the vehicle system 100 is damaged. The factory wheel travel (not shown) is the distance from the bottom of the suspension stroke to the top of the suspension stroke when the factory bed is attached to the frame. A custom wheel travel 126 is the distance from the bottom of the suspension stroke to the top of the suspension stroke when the custom bed 104 is attached to the frame. The custom wheel travel 126 is enabled because the fender of the custom bed 104 is higher than the fender of the factory bed. However, for the vehicle system 100 to have an increased wheel travel, the vehicle system 100 may need to be further modified (improved suspension, etc.). In the illustrated embodiment, the custom wheel travel 126 is greater than the factory wheel travel.

In general, a departure angle is defined as an angle between grade and a line drawn between a back wheel 110 and an end of the vehicle system 100 at a back overhang of the vehicle system 100. Departure angle typically indicates the maximum ramp angle from which the vehicle system 100 can descend without damage. The departure angle is typically one of the indicators of off-road ability of the vehicle system 100 because it indicates the steepness obstacles, such as rocks or logs, the vehicle system 100 can negotiate based on its body shape alone (e.g., the shape of the custom bed 104). The factory departure angle is the angle between grade and a line (not shown) drawn between the back wheel 110 and an end of the factory bed at a back overhang of the vehicle system 100. The custom departure angle 128 is the angle between grade and a line 132 drawn between the back wheel 110 and an end of the custom bed 104 at a back overhang of the vehicle system 100. In the illustrated embodiment, the custom departure angle 128 is greater than the factory departure angle.

In general, a center of mass or center of gravity of the vehicle system 100 is the point where a weighted relative position of a distributed mass of the vehicle system 100 sums to zero or the point to which a force may be applied to the vehicle system 100 to cause a linear acceleration without an angular acceleration. Typically, adding mass to an object above the center of mass of the object increases the center of mass. In vehicles, increasing the center of mass may cause the vehicle to become unstable because the center of mass is further way from the road. Specifically, when the center of mass is no longer above the space bounded by the wheels of the vehicle, an angular acceleration may be applied to the center of mass and the vehicle may roll over.

A factory center of mass (not shown) is a center of mass (not shown) of the vehicle system 100 when the factory bed (not shown) is attached to the frame. The custom center of mass 130 is a center of mass of the vehicle system 100 when the custom bed 104 is attached to the frame. The custom bed 104 described herein reduces or minimizes increases in the center of mass of the vehicle system 100 by maintaining the custom bed height 124 at a height that is approximately equal to or lower than the factory bed height.

Thus, the vehicle system 100 illustrated in FIG. 1 has a custom bed 104 that increases the off road capabilities of the vehicle system 100 while minimizing creases in the center of mass of the vehicle system 100. Specifically, in the illustrated embodiment, as described in greater detail below, the custom bed 104 is sized and shaped to maintain the custom bed height 124 at a height that is approximately equal to or lower than the factory bed height, increase the factory wheel travel to the custom wheel travel 126, increase the factory departure angle to the custom departure angle 128, and change the overall aesthetic of the vehicle system 100 to a more rugged aesthetic. As such, the custom bed 104 described herein improves the capabilities of the vehicle system 100 while minimizing increases in the center of mass of the vehicle system 100.

In the illustrated embodiment, the factory bed height is about 1.5 inches to about 4.0 inches and the custom bed height 124 is about 1.5 inches to about 4.0 inches. Additionally, in the illustrated embodiment, the factory wheel travel is about 6.0 inches to about 10.0 inches and the custom wheel travel 126 is about 6.0 inches to about 14.0 inches. Moreover, in the illustrated embodiment, the factory departure angle is about 10° to about 25° and the custom departure angle 128 is about 30° to about 75°, or about 35° to about 75°, or about 40° to about 75°, or about 45° to about 75°, or about 50° to about 75°, or about 55° to about 75°, or about 60° to about 75°, or about 65° to about 75°, or about 70° to about 75°, or about 35° to about 70°, or about 35° to about 65°, or about 35° to about 60°, or about 35° to about 55°, or about 35° to about 50°, or about 35° to about 45°, or about 35° to about 40°, or about 40° to about 70°, or about 45° to about 65°, or about 50° to about 60°, or about 55° to about 60°.

In alternative embodiments, the vehicle system 100 may include a cabin chassis truck (not shown) that deliberately does not include a factory bed. Rather cabin chassis trucks are designed to be manufactured and sold without factory beds to increase the versatility of the truck. Specifically, the user may attach a custom bed/attachment that is custom the user's purpose. However, because the cabin chassis truck does not include a factory bed, the custom bed height 124 is not defined relative to the factory bed height. Rather, the custom bed height 124 is defined relative to a top (not shown) of a cabin (not shown) of the cabin chassis truck. More specifically, in the illustrated embodiment with a cabin chassis truck, the custom bed height 124 is about 40 inches to about 50 inches below the top of the cabin of the cabin chassis truck. More specifically, the custom bed height 124 is about 44 inches below the top of the cabin of the cabin chassis truck. Alternatively, the custom bed height 124 is defined relative to a frame rail (not shown) of a frame (not shown) of the cabin chassis truck. More specifically, in the illustrated embodiment with a cabin chassis truck, the custom bed height 124 is about 1.5 inches to about 6 inches above the frame rail of the frame of the cabin chassis truck. More specifically, the custom bed height 124 is about 5.5 inches above the frame rail of the frame of the cabin chassis truck.

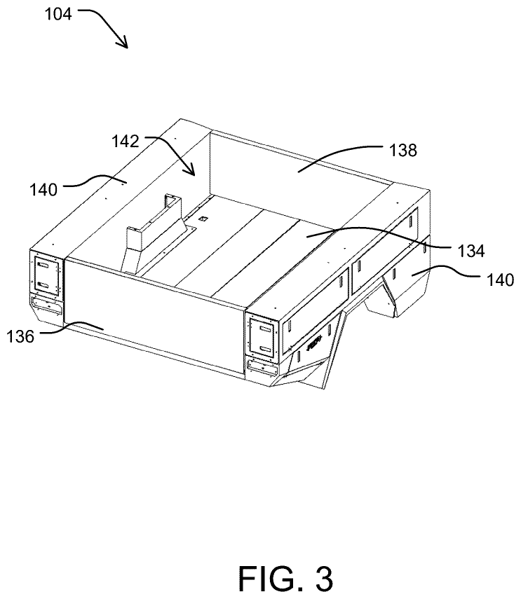

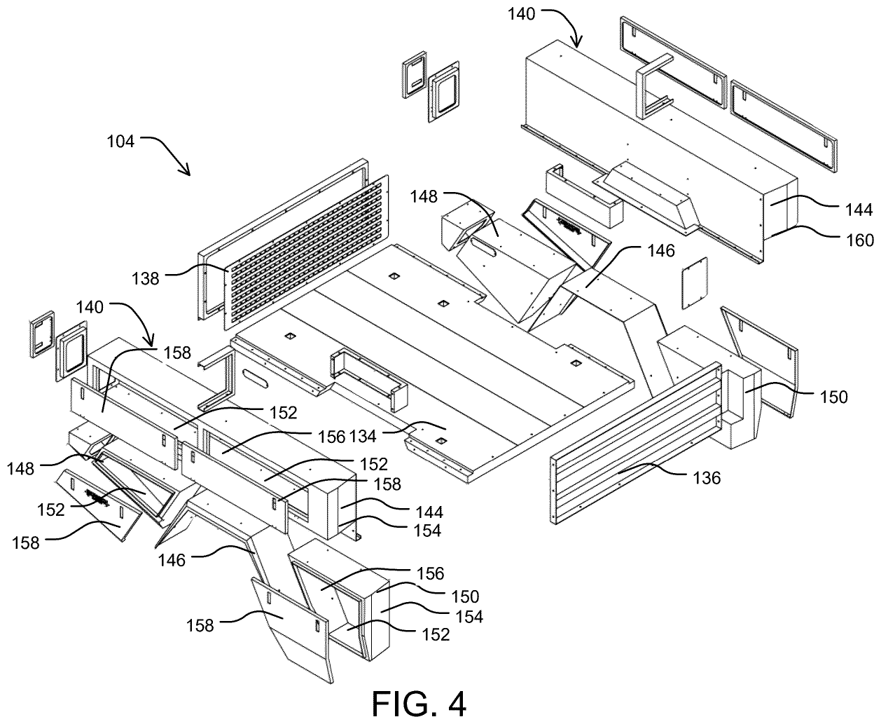

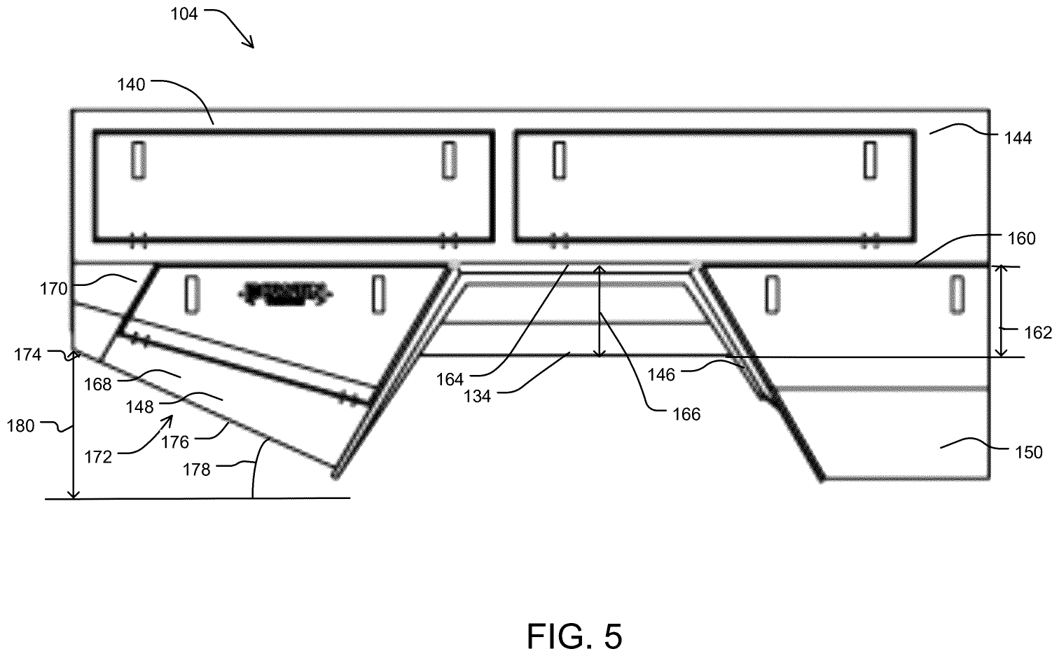

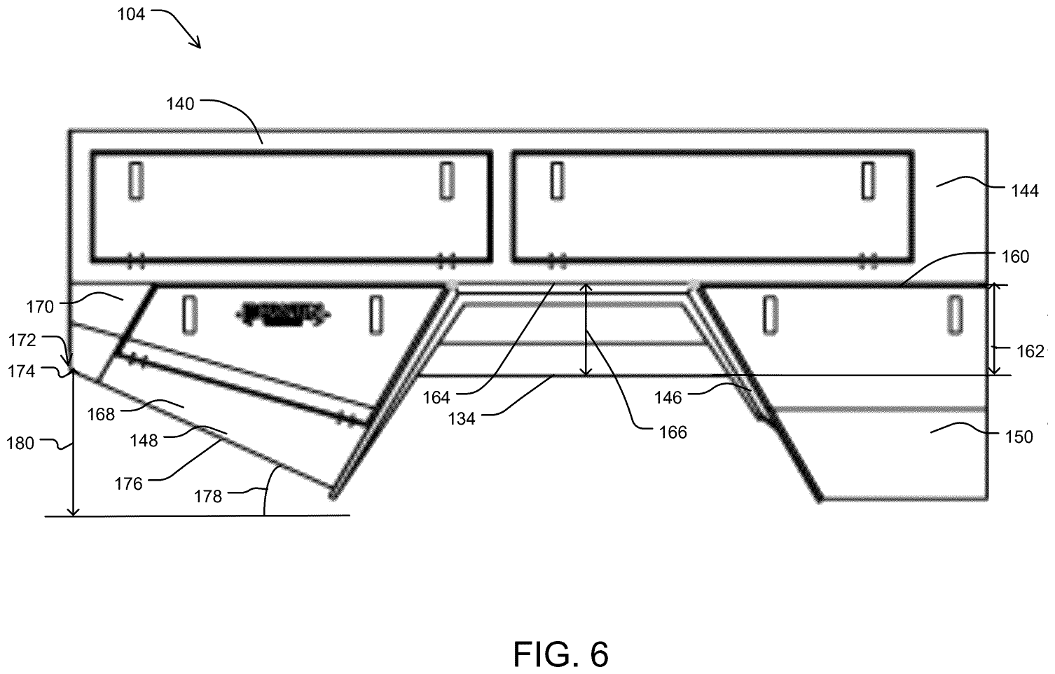

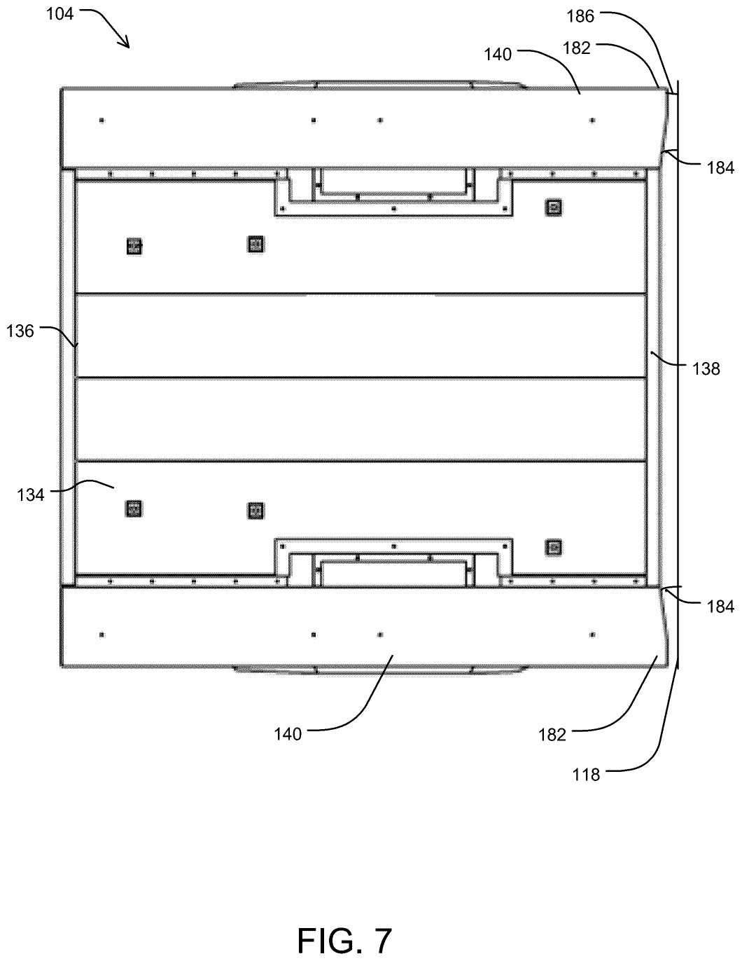

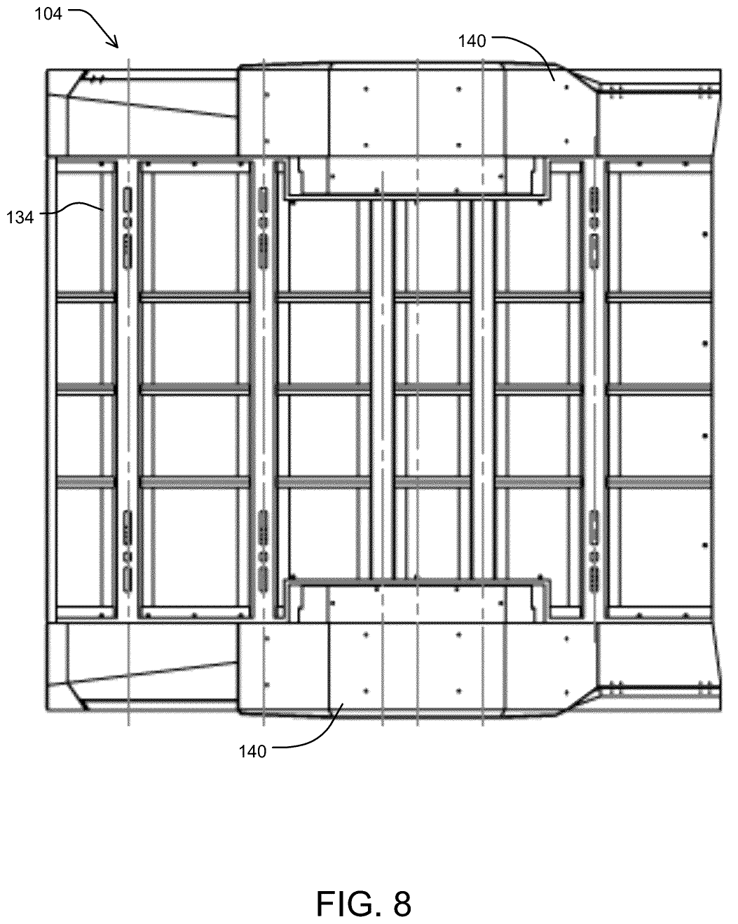

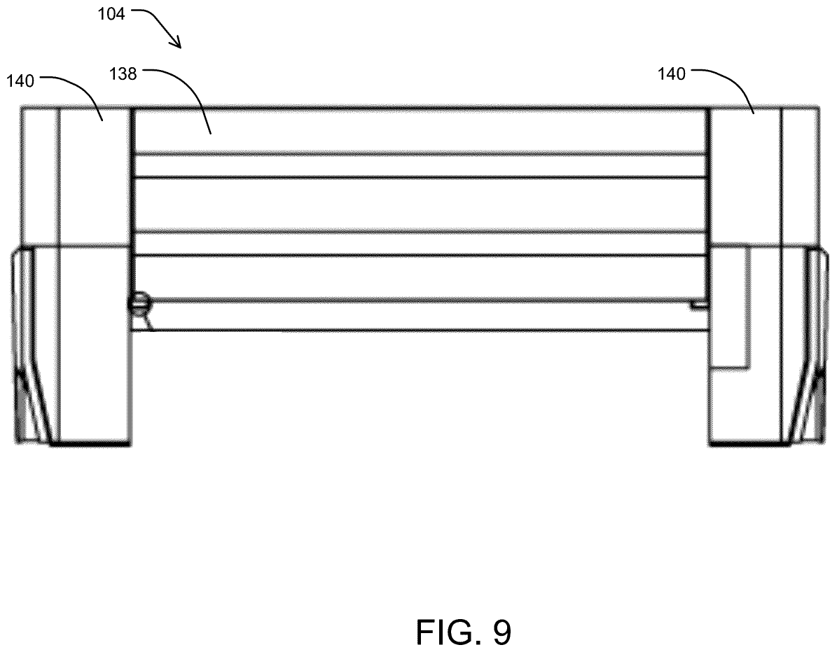

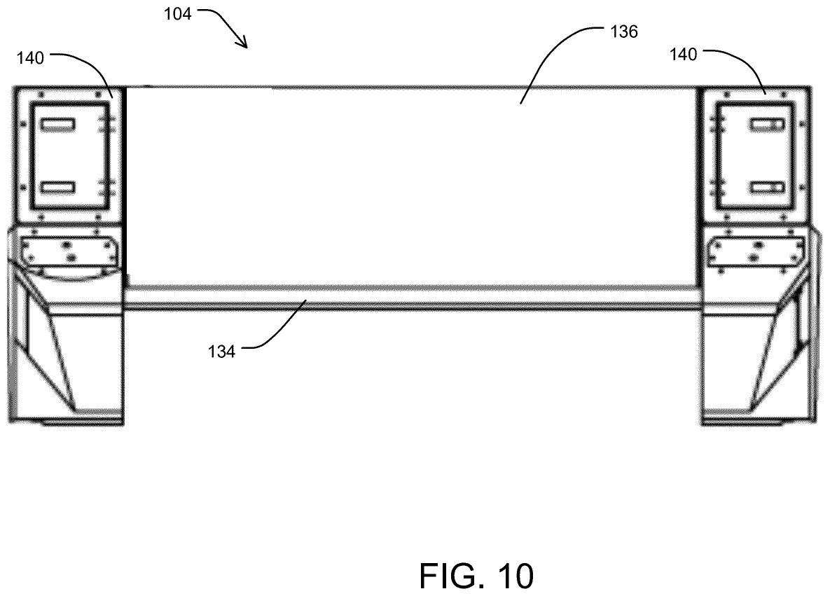

FIG. 2 illustrates a perspective view of the custom bed 104. FIG. 3 illustrates another perspective view of the custom bed 104. FIG. 4 illustrates an exploded perspective view of the custom bed 104. FIG. 5 illustrates a side view of the custom bed 104. FIG. 6 illustrates another side view of the custom bed 104. FIG. 7 illustrates a top view of the custom bed 104. FIG. 8 illustrates a bottom view of the custom bed 104. FIG. 9 illustrates a front view of the custom bed 104. FIG. 10 illustrates a back view of the custom bed 104.

As shown in FIGS. 2-10, the custom bed 104 includes a deck 134, a bulkhead 136, a tailgate 138, and two side/fender assemblies 140. The deck 134, the bulkhead 136, the tailgate 138, and the two side/fender assemblies 140 define a bed 142. The bed 142 is the volume of space generally defined by the deck 134, the bulkhead 136, the tailgate 138, and the two side/fender assemblies 140 with a top of the bed 142 not defined by a structure and open to the environment when the topper/camper 106 is not attached to the custom bed 104. The deck 134 is attached to the frame (not shown) such that the custom bed height 124 is positioned at a height that is approximately equal to the factory bed height. Maintaining the custom bed height 124 at a height that is approximately equal to the factory bed height, minimizes increases in the center of mass 130 of the vehicle system 100, improving the stability and the ride of the vehicle system.

The bulkhead 136 is attached to and extends from the deck 134. Specifically, the bulkhead 136 is configured to be attached to the deck 134 such that the bulkhead 136 extends vertically from the deck 134 and forms approximately a right angle (90° angle) with the deck 134. The bulkhead 136 at least partially defines a front portion of the bed 142 and is positioned proximate the second end 118 of the body 112 when the custom bed 104 is attached to the frame.

The tailgate 138 is attached to and extends from the deck 134. Specifically, the tailgate 138 is configured to be attached to the deck 134 such that the tailgate 138 extends vertically from the deck 134 and forms approximately a right angle (90° angle) with the deck 134 in a closed configuration. The tailgate 138 is configured to open into an open configuration to enable selective access to the bed 142. The tailgate 138 at least partially defines a back portion of the bed 142.

The two side/fender assemblies 140 are each attached to and extend from the sides of the deck 134. Specifically, the two side/fender assemblies 140 are configured to be attached to the deck 134 such that the two side/fender assemblies 140 each extend vertically from the deck 134 and each form approximately a right angle (90° angle) with the deck 134. The two side/fender assemblies 140 at least partially define side portions of the bed 142.

The two side/fender assemblies 140 typically form the primary support for the topper/camper 106. Specifically, the topper/camper 106 is typically attached primarily to the two side/fender assemblies 140 such that the two side/fender assemblies 140 provide most of the support for the topper/camper 106. In some embodiments, the topper/camper 106 may also be attached to the bulkhead 136 such that the bulkhead 136 may provide at least some support for the topper/camper 106 as well.

The two side/fender assemblies 140 each include an upper box assembly 144, a fender assembly 146, a rear lower box assembly 148, and a front lower box assembly 150. The fender assembly 146 is attached to the deck 134 and is configured to be positioned above one of the back wheels 110. The front lower box assembly 150 is attached to the deck 134 and the fender assembly 146 and is positioned forward of the fender assembly 146 toward the body 112 of the vehicle 102. The rear lower box assembly 148 is attached to the deck 134 and the fender assembly 146 and is positioned rearward of the fender assembly 146 away from the body 112 of the vehicle 102. The upper box assembly 144 it attached to the deck 134, the rear lower box assembly 148, the front lower box assembly 150, and the fender assembly 146 and is positioned above the rear lower box assembly 148, the front lower box assembly 150, and the fender assembly 146.

The upper box assembly 144, the rear lower box assembly 148, and the front lower box assembly 150 each define a plurality of storage spaces 152 configured to store equipment. Specifically, the upper box assembly 144, the rear lower box assembly 148, and the front lower box assembly 150 each include a plurality of sides 154 that define the storage spaces 152. Additionally, the sides 154 define a plurality of openings 156 that enable access to the storage spaces 152. The upper box assembly 144, the rear lower box assembly 148, and the front lower box assembly 150 each also include a plurality of doors 158 that cover the openings 156 and enable selective access to the storage spaces 152 when opened.

In the illustrated embodiment, the upper box assembly 144 has a lower edge 160 that is positioned an upper box distance 162 above the deck 134. The upper box distance 162 is configured to enable the fender assembly 146 above the deck 134 such that the custom wheel travel 126 of the vehicle system 100 is increased when the custom bed 104 is attached to the frame. More specifically, because the upper box assembly 144 is positioned above the fender assembly 146, it is necessary to increase a height of the upper box assembly 144 above grade to increase a height of the fender assembly 146 above grade to increase the custom wheel travel 126 above the factory wheel travel as described herein. In the illustrated embodiment, the upper box distance 162 is about 4 inches to about 12 inches.

As discussed above, the lower edge 160 of the upper box assembly 144 is positioned the upper box distance 162 above the deck 134 to enable the fender assembly 146 to be positioned above the deck 134 to enable the custom wheel travel 126 to be increased. Specifically, in the illustrated embodiment, a top 164 of the fender assembly 146 is positioned a fender assembly distance 166 above the deck 134 such that the custom wheel travel 126 of the vehicle system 100 is increased when the custom bed 104 is attached to the frame. More specifically, because the fender assembly 146 is positioned above the wheels 110, it is necessary to increase a height of the top 164 of the fender assembly 146 above grade to increase a distance the wheels 110 can travel toward the top 164 of the fender assembly 146. As such, the top 164 of the fender assembly 1446 is positioned the fender assembly distance 166 above the deck 134 to increase the custom wheel travel 126 above the factory wheel travel as described herein. In the illustrated embodiment, the fender assembly distance 166 is about 4 inches to about 12 inches.

In the illustrated embodiment, the rear lower box assembly 148 includes a rear box 168 and a taillight box 170. The rear box 168 and the taillight box 170 define a back overhang 172 of the vehicle system 100 and at least a portion of the back overhang 172 defines an end 174 of the vehicle system 100. Additionally, the rear box 168 and the taillight box 170 define a continuous lower edge 176 that is angle relative to grade to increase the custom departure angle 128. Specifically, the lower edge 176 forms a lower edge angle 178 relative to grade to increase the custom departure angle 128. More specifically, the lower edge angle 178 increases a distance 180 from grade of the end 174 of the vehicle system 100 as the back overhang 172 extends rearward from the back wheels 110 such that the custom departure angle 128 is increased. In the illustrated embodiment, the lower edge angle 178 is about 13° to about 25°.

The upper box assemblies 144 each have a front end 182 positioned proximate the second end 118 of the body 112. The front ends 182 are each angled forward as the front ends 182 extend toward the sides of the vehicle system 100 such that the front ends 182 are closer to the second end 118 of the body 112 proximate the sides of the vehicle system 100. That is, the front ends 182 define a front end angle 184 relative to the second end 118 of the body 112 such that a front end distance 186 between the front ends 182 and the second end 118 of the body 112 decreases proximate the sides of the vehicle system 100. In the illustrated embodiment, the front end angle 184 is about 6° to about 11° and the front end distance 186 is about 0 inches to about 2 inches proximate the sides of the vehicle system 100. Decreasing the front end distance 186 proximate the sides of the vehicle system 100 decreases aerodynamic drag on the vehicle system 100 and improves fuel efficiency.

As such, the custom bed 104 described herein is sized and shaped to improve the capabilities and the aesthetic of the vehicle system 100 while minimizing increases in the center of mass 130 of the vehicle system 100. First, the custom bed height 124 is maintained at a height that is approximately equal to the factory bed height to minimize increases in the center of mass 130 of the vehicle system 100. Next, the upper box assembly 144 and the fender assembly 146 are positioned the upper box distance 162 and the fender assembly distance 166 above the deck 134 to enable the custom wheel travel 126 to be increased above the factory wheel travel. Finally, the lower edge 176 of the rear lower box assembly 148 defines the lower edge angle 178 to increase the distance 180 from grade of the end 174 of the vehicle system 100 as the back overhang 172 extends rearward from the back wheels 110 such that the custom departure angle 128 is increased above the factory departure angle. The increased custom wheel travel 126 and the increased custom departure angle 128 increase the off road capabilities of the vehicle system 100. Maintaining the custom bed height 124 at a height that is approximately equal to the factory bed height minimizes increases in the center of mass 130 of the vehicle system 100. The shape of the custom bed 104 changes the aesthetic of the vehicle system 100 to a more rugged aesthetic. Accordingly, the custom bed 104 described herein improves the capabilities of the vehicle system 100 while minimizing increases in the center of mass 130 of the vehicle system 100.

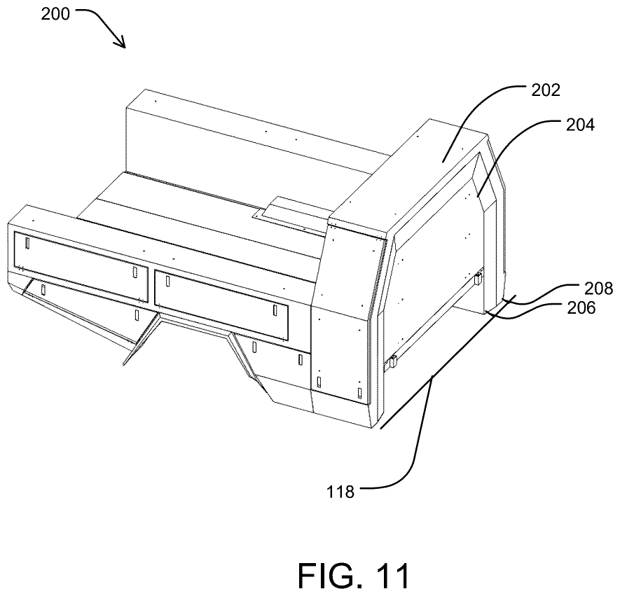

FIG. 11 illustrates a perspective view of a custom bed 200. The custom bed 200 is substantially similar to the custom bed 104 except that custom bed 200 includes a garage 202 positioned between the bulkhead 136 and the second end 118 of the body 112. The garage 200 includes additional storage spaces (not shown) to store equipment. The garage 202 is typically only installed on vehicles 102 with a longer factory bed. Similar to the upper box assemblies 144 described above, the garage 202 has a front end 204 positioned proximate the second end 118 of the body 112. The front end 204 is angled forward as the front end 204 extends toward the sides of the vehicle system 100 such that the front end 204 is closer to the second end 118 of the body 112 proximate the sides of the vehicle system 100. That is, the front end 204 defines a front end angle 206 relative to the second end 118 of the body 112 such that a front end distance 208 between the front end 204 and the second end 118 of the body 112 decreases proximate the sides of the vehicle system 100. In the illustrated embodiment, the front end angle 206 is about 6° to about 11° and the front end distance 208 is about 0 inches to about 2 inches proximate the sides of the vehicle system 100. Decreasing the front end distance 208 proximate the sides of the vehicle system 100 decreases aerodynamic drag on the vehicle system 100 and improves fuel efficiency.

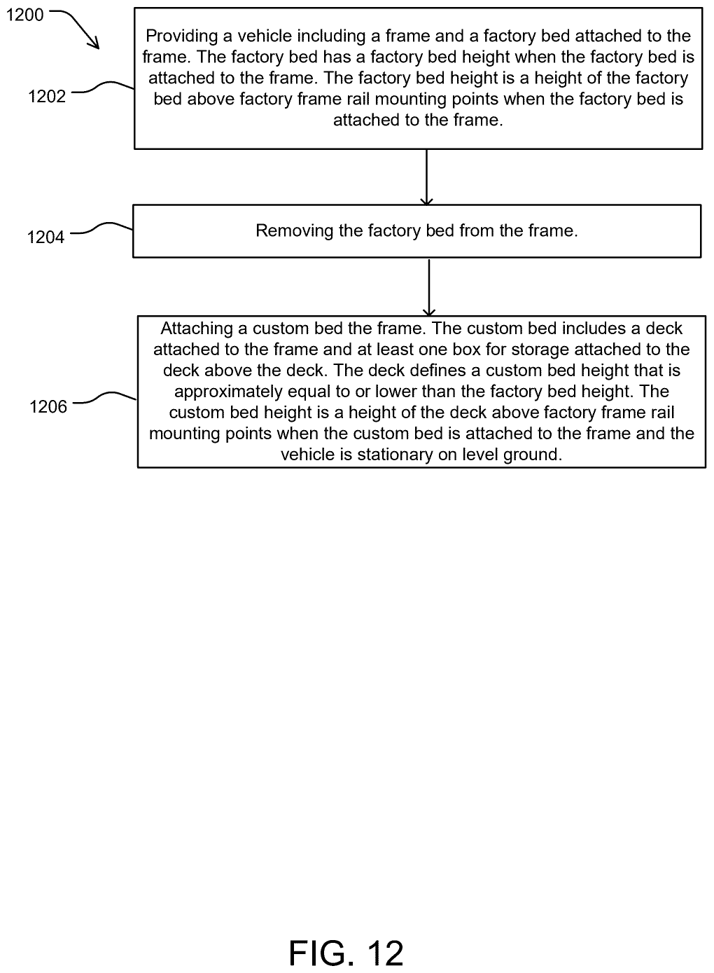

FIG. 12 illustrates a flow diagram of a method 1200 of manufacturing a vehicle system. The method 1200 includes providing 1202 a vehicle including a frame and a factory bed attached to the frame. The factory bed has a factory bed height when the factory bed is attached to the frame. The factory bed height is a height of the factory bed above factory frame rail mounting points when the factory bed is attached to the frame. The method 1200 also includes removing 1204 the factory bed from the frame. The method 1200 further includes attaching 1206 a custom bed the frame. The custom bed includes a deck attached to the frame and at least one box for storage attached to the deck above the deck. The deck defines a custom bed height that is approximately equal to or lower than the factory bed height. The custom bed height is a height of the deck above factory frame rail mounting points when the custom bed is attached to the frame and the vehicle is stationary on level ground.

The embodiments of the system and method for a vehicle system including a custom bed described herein improve the capabilities and the aesthetic of the vehicle system while minimizing increases in the center of mass of the vehicle system. Specifically, the custom bed is sized and shaped to maintain a custom bed height at a height that is approximately equal to a factory bed height, increase a factory wheel travel to a custom wheel travel, increase a factory departure angle to a custom departure angle, and change the overall aesthetic of the vehicle system to a more rugged aesthetic. The increased wheel travel and the increased departure angle increase the off road capabilities of the vehicle system. Maintaining the custom bed height at a height that is approximately equal to the factory bed height, minimizes increases in the center of mass of the vehicle system, improving the stability and the ride of the vehicle system. The shape of the custom bed changes the aesthetic of the vehicle system to a more rugged aesthetic. Accordingly, the custom beds described herein improves the capabilities of the vehicle system while minimizing increases in the center of mass of the vehicle system.

### Terminology and Interpretative Conventions

Any methods described in the claims or specification should not be interpreted to require the steps to be performed in a specific order unless stated otherwise. Also, the methods should be interpreted to provide support to perform the recited steps in any order unless stated otherwise.

Spatial or directional terms, such as “left,” “right,” “front,” “back,” and the like, relate to the subject matter as it is shown in the drawings. However, it is to be understood that the described subject matter may assume various alternative orientations and, accordingly, such terms are not to be considered as limiting.

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items.

The terms have, having, include, and including should be interpreted to be synonymous with the terms comprise and comprising. The use of these terms should also be understood as disclosing and providing support for narrower alternative embodiments where these terms are replaced by “consisting” or “consisting essentially of.”

Unless otherwise indicated, all numbers or expressions, such as those expressing dimensions, physical characteristics, and the like, used in the specification (other than the claims) are understood to be modified in all instances by the term “approximately.” At the very least, and not as an attempt to limit the application of the doctrine of equivalents to the claims, each numerical parameter recited in the specification or claims which is modified by the term “approximately” should be construed in light of the number of recited significant digits and by applying ordinary rounding techniques.

All disclosed ranges are to be understood to encompass and provide support for claims that recite any and all subranges or any and all individual values subsumed by each range. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

All disclosed numerical values are to be understood as being variable from 0-100% in either direction and thus provide support for claims that recite such values or any and all ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range (e.g., 15.2).

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

The subject matter recited in the claims is not coextensive with and should not be interpreted to be coextensive with any embodiment, feature, or combination of features described or illustrated in this document. This is true even if only a single embodiment of the feature or combination of features is illustrated and described in this document.

What is claimed:

1. A vehicle system comprising:
a vehicle comprising a frame and a factory bed which has been removed from the frame, the frame including at least one factory frame rail mounting point, wherein the factory bed had a factory bed height when the factory bed was attached to the frame, and wherein the factory bed height is a height of the factory bed above the at least one factory frame rail mounting point when the factory bed was attached to the frame; and
a custom bed attached to the frame, the custom bed comprising a deck attached to the frame and at least one box for storage attached to the deck above the deck, wherein the deck defines a custom bed height that is approximately equal to or lower than the factory bed height, and wherein the custom bed height is a height of the deck above the at least one factory frame rail mounting point when the custom bed is attached to the frame.

2. The vehicle system of claim 1, further comprising a topper or camper attached to the custom bed.

3. The vehicle system of claim 2, wherein the topper or camper comprises a truck topper.

4. The vehicle system of claim 2, wherein the topper or camper comprises a camper.

5. The vehicle system of claim 1, wherein the factory bed height is about 1.0 inches to about 4.0 inches.

6. The vehicle system of claim 1, wherein the custom bed height is about 1.0 inches to about 4.0 inches.

7. The vehicle system of claim 1, wherein the vehicle comprises a plurality of wheels each having a suspension having a suspension stroke, wherein a wheel travel is defined as a distance from a bottom of the suspension stroke of at least one of the wheels to a top of the suspension stroke of the at least one of the wheels, wherein the vehicle has a factory wheel travel when the factory bed is attached to the frame, wherein the vehicle system has a custom wheel travel when the custom bed is attached to the frame, and wherein the custom wheel travel is equal to or greater than the factory wheel travel.

8. The vehicle system of claim 7, wherein the factory wheel travel is about 6.0 inches to about 10.0 inches.

9. The vehicle system of claim 8, wherein the custom wheel travel is about 6.0 inches to about 14.0 inches.

10. The vehicle system of claim 1, wherein a departure angle is defined as an angle between grade and a line drawn between a back wheel and an end of the vehicle at a back overhang of the vehicle, the vehicle has a factory departure angle when the factory bed is attached to the frame and a custom departure angle when the custom bed is attached to the frame, wherein the custom departure angle is equal to or greater than the factory departure angle.

11. The vehicle system of claim 10, wherein the factory departure angle is about 10° to about 25°.

12. The vehicle system of claim 11, wherein the custom departure angle is about 30° to about 75°.

13. The vehicle system of claim 10, wherein the at least one box comprises at least one lower box attached to the deck behind the back wheel, the at least one lower box comprises the end of the vehicle at the back overhang of the vehicle.

14. The vehicle system of claim 13, wherein the at least one lower box has a lower edge, wherein the lower edge is angled to increase the custom departure angle.

15. The vehicle system of claim 14, wherein the lower edge defines a lower edge angle of about 13° to about 25°.

16. The vehicle system of claim 10, wherein the vehicle comprises a plurality of wheels each having a suspension having a suspension stroke, wherein a wheel travel is defined as a distance from a bottom of the suspension stroke of at least one of the wheels to a top of the suspension stroke of the at least one of the wheels, wherein the vehicle system has a custom wheel travel when the custom bed is attached to the frame, and wherein the custom wheel travel is greater than the factory wheel travel, wherein the custom wheel travel is about 6.0 inches to about 14.0 inches.

17. The vehicle system of claim 1, wherein a departure angle is defined as an angle between grade and a line drawn between a back wheel and an end of the vehicle at a back overhang of the vehicle, the vehicle has a custom departure angle when the custom bed is attached to the frame, wherein the custom departure angle is about 30° to about 75°.

18. The vehicle system of claim 1, wherein the at least one box comprises at least one upper box attached to the deck, wherein a bottom of the at least one upper box is positioned an upper box distance above the deck.

19. The vehicle system of claim 1, wherein the at least one box comprises a plurality of upper boxes attached to the deck and a plurality of lower boxes attached to the deck, wherein the plurality of upper boxes and the plurality of lower boxes are removably attached to the deck such that the plurality of upper boxes and the plurality of lower boxes are modular.

20. A method of manufacturing a vehicle system, the method comprising:
providing a vehicle comprising a frame and a factory bed attached to the frame, the frame including at least one factory frame rail mounting point, wherein the factory bed has a factory bed height when the factory bed is attached to the frame, and wherein the factory bed height is a height of the factory bed above factory frame rail mounting points when the factory bed is attached to the frame;
removing the factory bed from the frame;
attaching a custom bed the frame, the custom bed comprising a deck attached to the frame and at least one box for storage attached to the deck, wherein the deck defines a custom bed height that is approximately equal to the factory bed height, and wherein the custom bed height is a height of the deck above the at least one factory frame rail mounting points when the custom bed is attached to the frame.
